(19) United States
(12) Patent Application Publication
(10) Pub. No.: US 2009/0162772 A1
(43) Pub. Date: Jun. 25, 2009

(54) IMAGE FORMING METHOD

(76) Inventors: Kazuoki FUWA, Kawanishi-shi (JP); Shinobu Fujiki, Nagaokakyo-shi (JP); Yutaka Naitoh, Itami-shi (JP); Yasuhide Ohkubo, Toyonaka-shi (JP); Shin Murayama, Mita-shi (JP)

Correspondence Address: OBLON, SPIVAK, MCCLELLAND MAIER & NEUSTADT, P.C., 1940 DUKE STREET, ALEXANDRIA, VA, 22314, US

(21) Appl. No.: 12/325,702

(22) Filed: Dec. 1, 2008

(30) Foreign Application Priority Data
Dec. 21, 2007 (JP) 2007-330202

(51) Int. Cl. G03G 9/08; G03G 13/06; G03G 15/08

(52) U.S. Cl. 430/108.1; 430/97; 399/279

(57) ABSTRACT

An image forming method, including forming an electrostatic latent image on a latent image bearer; forming a thin layer of a toner on a developing roller with a thin-layer forming member; and feeding the toner with the developing roller to the electrostatic latent image to develop the electrostatic latent image, wherein the toner is a pulverized toner, including a binder resin; a wax; and an inorganic particulate material, and wherein the following relationships (1) to (3) are satisfied:

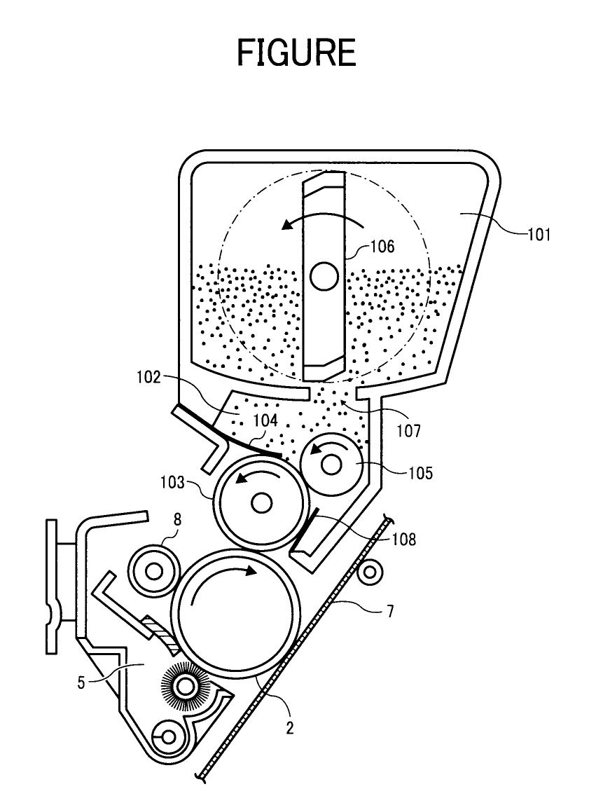

300≧v≧100 (1)

10≧R≧5 (2)

R²/12≧A≧150/v (3)

wherein v represents a peripheral speed of the developing roller; R represents a diameter of the developing roller; and A represents an exposure of the wax on the surface of the toner.

### BACKGROUND OF THE INVENTION

1. Field of the Invention

The present invention relates to an image forming method, and more particularly to an image forming method using a non-magnetic one-component developer and an oilless fixation.

2. Discussion of the Background

Japanese Patent No. 3919541 discloses a one-component developer and a process cartridge, preventing reverse foggy images due to rising temperature and improving white spots on images, having no longitudinal stripes and filming for long periods and having no foggy images and defective fixation under an environment of high temperature and high humidity. The process cartridge includes a latent image bearer having a diameter not greater than 33 mm, a developer container, a toner bearer contacting the latent image bearer and having a diameter not greater than 20 mm, a toner feed roller contacting the toner bearer and a toner conveyor conveying a toner to the toner feed roller. The toner conveyor has a rotation number ratio to the toner feed roller of from 0.1 to 0.5, and the following relationship is satisfied:

9B≦A≦3B

wherein A is a toner amount on the toner bearer and B is a filling rate of the toner in the developer container.

The toner includes at least a binder resin, a colorant and a wax, and has a methanol half-value wettability of from 30 to 80%.

However, the relationship between the surface exposure of the wax and methanol half-value wettability is not clarified, and when the developing roller has a diameter not greater than 10 mm, anchoring of a wax due to wax effusion cannot be prevented.

The electrophotographic dry developing methods include a method of using a two-component developer including a toner and a carrier, and a method of using a one-component developer not including a carrier. Lately, low-end laser printers require downsizing, and the latter method of using a one-component developer is being watched. In a one-component image developer, a thin-layer former facing a developing roller presses a toner fed onto the developing roller to control the thickness of a toner layer, and charges the toner.

However, the thin-layer former is heated with a friction with the developing roller. In addition, the developing roller effectively has a smaller diameter for further downsizing, but the thin-layer former is more heated as the developing roller has a smaller diameter, resulting in anchoring of the wax.

Because of these reasons, a need exists for an image forming method of producing quality images without anchoring of a wax, using a developer having a diameter of from 5 to 10 mm and a linear speed not less than 100 mm/sec.

### SUMMARY OF THE INVENTION

Accordingly, an object of the present invention is to provide an image forming method of producing quality images without anchoring of a wax, using a developer having a diameter of from 5 to 10 mm and a linear speed not less than 100 mm/sec.

Another object of the present invention is to provide a toner for use in the image forming method.

A further object of the present invention is to provide an image forming apparatus using the image forming method.

These objects and other objects of the present invention, either individually or collectively, have been satisfied by the discovery of an image forming method, comprising:

forming an electrostatic latent image on a latent image bearer;

forming a thin layer of a toner on a developing roller with a thin-layer forming member; and

feeding the toner with the developing roller to the electrostatic latent image to develop the electrostatic latent image,

wherein the toner is a pulverized toner, comprising:

a binder resin;

a wax; and

an inorganic particulate material, and

wherein the following relationships (1) to (3) are satisfied:

300≧v≧100 (1)

10≧R≧5 (2)

R²/12≧A≧150/v (3)

wherein v represents a peripheral speed of the developing roller; R represents a diameter of the developing roller; and A represents an exposure of the wax on the surface of the toner.

These and other objects, features and advantages of the present invention will become apparent upon consideration of the following description of the preferred embodiments of the present invention taken in conjunction with the accompanying drawing.

### BRIEF DESCRIPTION OF THE DRAWING

Various other objects, features and attendant advantages of the present invention will be more fully appreciated as the same becomes better understood from the detailed description when considered in connection with the accompanying drawing in which like reference characters designate like corresponding parts throughout and wherein:

FIGURE is a schematic view illustrating a longitudinal cross-section of the image developer and process cartridge of the present invention.

### DETAILED DESCRIPTION OF THE INVENTION

The present invention provides an image forming method of producing quality images without anchoring of a wax, using a developer having a diameter of from 5 to 10 mm and a linear speed not less than 100 mm/sec. More particularly, the present invention relates to an image forming method, comprising:

forming an electrostatic latent image on a latent image bearer;

forming a thin layer of a toner on a developing roller with a thin-layer forming member; and

feeding the toner with the developing roller to the electrostatic latent image to develop the electrostatic latent image,

wherein the toner is a pulverized toner, comprising:

a binder resin;

a wax; and

an inorganic particulate material, and

wherein the following relationships (1) to (3) are satisfied:

300≧v≧100 (1)

10≧R≧5 (2)

R²/12≧A≧150/v (3)

wherein v represents a peripheral speed (mm/sec) of the developing roller; R represents a diameter (mm) of the developing roller; and A represents an exposure (mg/g) of the wax on the surface of the toner.

When the exposure of the wax on the surface of the toner is not greater than R²/12, the wax melts out less due to the heated thin-layer forming member, which prevents the wax from being anchored on the thin-layer forming member. When not less than 150/v, the separativeness of the toner when fixed is maintained. When the linear speed is not greater than 300 mm, the thin-layer forming member is heated less, which prevents the wax from being anchored on the thin-layer forming member.

The toner preferably includes a wax in an amount of from 3 to 10% by weight. When not less than 3% by weight, the separativeness of the toner when fixed is maintained. When not greater than 10% by weight, the toner does not have a crack originating from the wax when forming a thin layer, which prevents the wax from being anchored on the thin-layer forming member.

The toner preferably has a maximum endothermic peak in a range of from 65 to 85° C. in a range of 30 to 200° C. of an endothermic curve obtained by differential scanning calorimetry. The maximum endothermic peak not less than 65° C. prevents the wax from exuding when a thin layer of the toner is formed, which prevents the wax from being anchored on the thin-layer forming member. When not greater than 68° C., the wax exudes in a suitable amount when the toner is fixed, which maintains the separativeness of the toner.

The toner preferably has a softening point of from 110 to 140° C. When less than 110° C., the toner is cracked more when forming a thin layer and a fine powder thereof increases, resulting in occasional anchoring thereof on the thin-layer forming member. When greater than 140° C., the toner does not melt when fixed and the separativeness thereof occasionally deteriorates.

The toner preferably has a volume-average particle diameter of from 5.0 to 10.0 μm. When less than 5.0 μm, the adherence thereof noticeably increases and the toner is likely to anchor on the thin-layer forming member. When greater than 10.0 μm, high-definition images are not produced occasionally.

The toner preferably includes the inorganic particulate material in an amount of from 2.0 to 4.5 parts by weight. When less than 2.0 parts by weight, the toners adhere to each other more and are likely to anchor on the thin-layer forming member. When greater than 4.5 parts by weight, the inorganic particulate material leaves from the toner more and the resultant images occasionally have noises.

The inorganic particulate material preferably has an adherence strength of from 30 to 80%. When less than 30%, the inorganic particulate material is released from the toner as time passes, and the toners agglutinate with each other more and are likely to anchor on the thin-layer forming member. When greater than 80%, the fluidity of the toner deteriorates and the toner occasionally anchors on the thin-layer forming member.

The toner preferably adheres on the developer roller in an amount not greater than 7 mg/cm². When greater than 7 mg/cm², a heat is not thoroughly transferred through the toner and the separativeness thereof occasionally deteriorates.

A mother toner for use is the present invention typically includes a binder resin, a colorant and other additives. The mother toner is prepared by melting, kneading and uniformly dispersing a colorant, a charge controlling agent, a release agent, etc. in a binder resin to prepare a constituent; and pulverizing and classifying the constituent.

The binder resins are not limited, and may be known resins such as polyester resins, (meth)acrylic resins, styrene-(meth) acrylic copolymer resins, epoxy resins and cyclic olefin resins, e.g., TOPAS-COC from Ticona. The polyester resins are preferably used in terms of stress resistance in an image developer.

The polyester resin is typically formed by polycondensation between a polyol and a polycarboxylic acid. Specific examples of diols in the polyols include adducts of a bisphenol A such as polyoxypropylene(2,2)-2,2-bis(4-hydroxyphenyl)propane, polyoxypropylene(3,3)-2,2-bis(4-hydroxyphenyl)propane, polyoxypropylene(6)-2,2-bis(4-hydroxyphenyl)propane, polyoxyethylene(2,0)-2,2-bis(4-hydroxyphenyl)propane; ethylene glycol; diethylene glycol; triethylene glycol; 1,2-propylene glycol; 1,3-propylene glycol; 1,4-butadieneol; neo-pentyl glycol; 1,4-butenediol; 1,5-pentanediol; 1,6-hexanediol; 1,4-cyclohexanedimethanol; dipropyleneglycol; polyethyleneglycol; polytetramethyleneglycol; bisphenol A; hydrogenated bisphenol A; etc. Specific examples of tri- or more valent alcohols include sorbitol, 1,2,3,6-hexanetetrol, 1,4-sorbitan, pentaerythritol, dipentaerythritol, tripentaerythritol, 1,2,4-butanetriol, 1,2,5-pentanetriol, glycerol, diglycerol, 2-methylpropanetriol, 2-methyl-1,2,4-butanetriol, trimethylolethane, trimethylolpropane, 1,3,5-trihydroxybenzene, etc.

Specific examples of dicarboxylic acids in the polycarboxylic acids include a maleic acid, a fumaric acid, a citraconic acids, an itaconic acid, a glutaconic acid, a phthalic acid, an isophthalic acid, a terephthalic acid, a cyclohexane dicarboxylic acid, a succinic acid, an adipic acid, a sebacic acid, an azelaic acid, a malonic acid, a n-dodecenylsuccinic acid, an isododecenylsuccinic acid, a n-dodecylsuccinic acids, an isododecylsuccinic acid, a n-octenylsuccinic acid, an isooctenylsuccinic acid, a n-octylsuccinic acid, an isooctylsuccinic acid, their anhydrides or lower alkyl esters, etc.

Specific examples of tri- or more carboxylic acids include a 1,2,4-benzenetricarboxylic acid, a 2,5,7-naphthalenetricarboxylic acid, a 1,2,4-naphthalenetricarboxylic acid, a 1,2,4-butanetricarboxylic acid, a 1,2,5-hexanetricarboxylic acid, 1,3-dicarboxyl-2-methyl-methylenecarboxypropane, tetra(methylenecarboxyl)methane, a 1,2,7,8-octantetracarboxylic acid, an empol trimer acid, and their anhydrides and lower alkyl esters, etc.

In the present invention, a vinyl polyester resin is preferably used, which is prepared by a combination of a polycondensation reaction forming a polyester resin and a radical polymerization reaction forming a vinyl resin in a same container, using a mixture of a polyester resin material monomer, a vinyl resin material monomer and a monomer reacting with the both material monomers. The monomer reacting with the both material monomers is, i.e., a monomer usable in both of the polycondensation reaction and radical polymerization reaction. Namely, the monomer is a monomer having a polycondensation-reactable carboxyl group and a radical-polymerization-reactable vinyl group such as a fumaric acid, a maleic avid, an acrylic acid and a methacrylic acid.

The polyester resin material monomer includes the above-mentioned polyols and polycarboxylic acids. The vinyl material monomer includes styrenes or their derivatives such as styrene, o-methylstyrene, m-methylstyrene, p-methylstyrene, α-methylstyrene, p-ethylstyrene, 2,4-dimethylstyrene, p-tert-butylstyrene and p-chlorostyrene; ethylene unsaturated monoolefins such as ethylene, propylene, butylene and isobutylene; methacrylate alkyl esters such as methylmethacrylate, n-propylmethacrylate, isopropylmethacrylate, n-butylmethacrylate, isobutylmethacrylate, t-butylmethacrylate, n-pentylmethacrylate, isopentylmethacrylate, neopentylmethacrylate, 3-(methyl)butylmethacrylate, hexylmethacrylate, octylmethacrylate, nonylmethacrylate, decylmethacrylate, undecylmethacrylate and dodecylmethacrylate; acrylate alkyl esters such as methylacrylate, n-propylacrylate, isopropylacrylate, n-butylacrylate, isobutylacrylate, t-butylacrylate, n-pentylacrylate, isopentylacrylate, neopentylacrylate, 3-(methyl)butylacrylate, hexylacrylate, octylacrylate, nonylacrylate, decylacrylate, undecylacrylate and dodecylacrylate; unsaturated carboxylic acids such as an acrylic acid, a methacrylic acid, an itaconic acid and a maleic acid; acrylonitrile; maleate ester; itaconate ester; vinylchloride; vinylacetate; vinylbenzoate; vinylmethylethylketone; vinylhexylketone; vinylmethylether; vinylethylether; vinylisobutylether; etc.

Specific examples of a polymerization initiator for polymerizing the vinyl resin material monomer include azo or diazo polymerization initiators such as 2,2′-azobis(2,4-dimethylvaleronitrile), 2,2′-isobutyronitrile, 1,1′-azobis(cyclohexane-1-carbonitrile) and 2,2′-azobis-4-methoxy-2,4-dimethylvaleronitrile; and peroxide polymerization initiators such as benzoylperoxide, dicumylperoxide, methylethylketoneperoxide, isopropylperoxycarbonate and lauroylperoxide.

The above-mentioned polyester resins are preferably used as a binder resin, and the following first and second binder resins are more preferably used in terms of improving the separativeness and offset resistance of the resultant oilless-fixing toner.

The first binder resin is a polyester resin prepared by polycondensating an adduct of bisphenol A with alkyleneoxide as the polyol, and a terephthalic acid and a fumaric acid as the polycarboxylic acid.

The second binder resin is a vinyl polyester resin prepared by using an adduct of bisphenol A with alkyleneoxide, a terephthalic acid, a trimellitic acid and a succinic acid as the polyester resin material monomer; styrene and butylacrylate as the vinyl resin material monomer; and a fumaric acid as the monomer reactive with both of the material monomers.

The first binder resin may include a hydrocarbon wax as mentioned above. In order to include a hydrocarbon wax in the first binder resin, the hydrocarbon wax is included in monomers forming the first binder resin when synthesized. For example, the hydrocarbon wax is included in an acid monomer and an alcohol monomer forming a polyester resin as the first binder resin, and the acid monomer and alcohol monomer are polycondensated. When the first binder resin is a vinyl polyester resin, the hydrocarbon wax is included in a polyester resin material monomer and a vinyl resin material monomer is dropped therein while stirred and heated to perform a polycondensation reaction and a radical polymerization reaction.

Typically, the lower the polarity of a wax, the better the releasability thereof from a fixing member (roller). The wax for use in the present invention is a hydrocarbon wax having a low polarity, and soluble in hexane. The toner preferably includes the wax in an amount of from 3.0 to 10.0% by weight, and more preferably from 4.0 to 8.0% by weight.

The toner of the present invention may include a wax dispersant improving dispersion of the wax. The wax dispersants are not particularly limited, and known wax dispersants can be used. Specific examples thereof include polymers and oligomers including a block formed of a unit having high compatibility with a wax and a unit having high compatibility with a resin; polymers and oligomers wherein either of a unit having high compatibility with a wax and a unit having high compatibility with a resin is grafted with the other; copolymers of unsaturated hydrocarbons such as ethylene, propylene, butene, styrene and α-styrene and α,β-unsaturated carboxylic acids, their esters or anhydrides such as an acrylic acid, a methacrylic acid, a maleic acid, a maleic acid anhydride, an itaconic acid and an itaconic acid anhydride; and a block or grafted body of vinyl resins and polyester.

Specific examples of the unit having high compatibility with a wax include long-chain alkyl groups having 12 or more carbon atoms, polyethylene, polypropylene, polybutene, polybutadiene and their copolymers. Specific examples of the unit having high compatibility with a resin include polyesters and vinyl resins.

Known colorants conventionally used in full color toners can be used in the toner of the present invention. Specific examples of the colorant include carbon black, Aniline Blue, calcoil blue, chrome yellow, ultramarine blue, Dupont Oil Red, QUINOLINE YELLOW, Methylene blue-chloride, Copper Phthalocyanine, Malachite Green Oxalate, lamp black, Rose Bengal, C.I. Pigment Red 48:1, C.I. Pigment Red 122, C.I. Pigment Yellow 97, C.I. Pigment Yellow 12, C.I. Pigment Yellow 17, C.I. Pigment Yellow 74, C.I. Solvent Yellow 162, C.I. Pigment Yellow 180, C.I. Pigment Yellow 185, C.I. Pigment Blue 15:1, C.I. Pigment Blue 15:3, etc. The toner preferably includes the colorant in an amount of from 2 to 15 parts by weight per 100 parts by weight of all the binder resin. The colorant is preferably dispersed in a mixed binder resin of the first and second binder resins in the form of a masterbatch. The masterbatch preferably includes the colorant in an amount of from 20 to 40% by weight.

Known charge controlling agents conventionally used in full color toners can be used.

Specific examples thereof include Nigrosine dyes, triphenylmethane dyes, chromium-containing metal complex dyes, molybdic acid chelate pigments, Rhodamine dyes, alkoxyamines, quaternary ammonium salts (including fluorine-modified quaternary ammonium salts), alkylamides, phosphor and its compounds, tungsten and its compounds, fluorine-containing activators, metal salts of salicylic acid, metal salts of salicylic acid derivatives, etc. Specific examples of marketed charge controlling agents include BONTRON P-51 (quaternary ammoniumsalt), BONTRONE-82 (metal complexof oxynaphthoic acid), BONTRON E-84 (metal complex of salicylic acid), and BONTRON E-89 (phenolic condensation product), which are manufactured by Orient Chemical Industries Co., Ltd.; TP-302 and TP-415 (molybdenum complex of quaternary ammonium salt), which are manufactured by Hodogaya Chemical Co., Ltd.; COPY CHARGE PSY VP2038 (quaternary ammonium salt), COPY BLUE (triphenyl methane derivative), COPY CHARGE NEG VP2036 and COPY CHARGE NX VP434 (quaternary ammonium salt), which are manufactured by Hoechst AG; LRA-901, and LR-147 (boron complex), which are manufactured by Japan Carlit Co., Ltd.; quinacridone, azo pigments, and polymers having a functional group such as a sulfonate group, a carboxyl group, a quaternary ammonium group, etc. Particularly, a charge controlling agent controlling a toner so as to have a negative polarity is preferably used.

The content of the charge controlling agent in the toner is determined depending on the variables such as choice of binder resin, presence of additives, and dispersion method. In general, the content of the charge controlling agent is preferably from 0.1 to 10 parts by weight, and more preferably from 0.2 to 5 parts by weight, per 100 parts by weight of the binder resin included in the toner.

In the present invention, an inorganic particulate material can be used as an external additive to support the fluidity and developability of the resultant toner.

Specific examples of the inorganic particulate material include silicon oxide, zinc oxide, tin oxide, quartz sand, titanium oxide, clay, mica, sand-lime, diatom earth, chromium oxide, ceriumoxide, redironoxide, antimonytrioxide, magnesium oxide, zirconium oxide, barium sulfate, barium carbonate, calcium carbonate, silicon carbide, silicon nitride, etc.

FIGURE is a schematic view illustrating a longitudinal cross-section of the image developer and process cartridge of the present invention.

The image developer includes a toner containing room (101), a toner feeding room (102) located below the toner containing room (101), a developing roller (103) below the toner feeding room (102), a layer regulation member (104) located contacting the developing roller (103) and a feed roller (105). The developing roller (103) is located contacting a photoreceptor drum (20) and is applied with a predetermined developing bias from a high-voltage electric source (not shown). The toner containing room (101) includes a toner stirring member (106) rotating anticlockwise. The toner stirring member (106) has a larger area at a part not passing near an opening (107) in the axial direction, and fully fluidizes and stirs a toner in the toner containing room (101). The toner stirring member (106) has a smaller area at a part passing near the opening (107) and prevents an excessive amount of the toner from leading thereto. The toner near the opening (107) is adequately stirred by the toner stirring member, passes through the opening (107) and falls into the toner feeding room (102) under its own weight. The surface of the feed roller (105) is coated with a foamed material having cells, efficiently absorbs the toner fallen into toner feeding room (102) and prevents the toner from deteriorating due to concentration of pressure at a contact point with the developing roller (103). The foamed material has an electrical resistivity of from 10³ to 10¹⁴ Ω·cm.

The feed roller (105) is applied with a feed bias offset in the same direction of the charge polarity of the toner against the developing bias. The feed bias presses the preliminarily-charged toner toward the developing roller (103) at a contact point therewith. However, the offset direction is not limited thereto, the offset may be zero or the offset direction may be changed depending upon the toner. The feed roller (105) rotates anticlockwise and feeds the toner adhering to the surface thereof to the surface of the developing roller (103) like coating. The developing roller (103) is coated with an elastic rubber layer and further coated with a surface layer formed of a material easily chargeable to have a polarity reverse to that of the toner. The elastic rubber layer has a hardness not greater than 60° when measured by JIS-A to prevent the toner from deteriorating due to concentration of pressure at a contact point with the layer regulation member (104). The elastic rubber layer has a surface roughness Ra of from 0.3 to 2.0 μm and holds a required amount of the toner at the surface thereof. The developing roller (103) rotates anticlockwise and transfers the toner held at the surface thereof to the layer regulation member (104) and to a position facing the photoreceptor drum (20). The layer regulation member (104) is located at a position lower than the contact point between the feed roller (105) and the developing roller (103), and is a metallic plate spring material formed of SUS, phosphor bronze, etc. The layer regulation member (104) contacts its free end to the surface of the developing roller (103) at a pressure of from 10 to 40 N/m, and thins a layer of the toner and frictionally charges the toner. Further, the layer regulation member (104) is applied with a regulation bias offset in the same direction of the charge polarity of the toner against the developing bias to assist when frictionally charging the toner. The photoreceptor drum (20) rotates clockwise, and therefore the surface of the developing roller (103) travels in the same direction of the traveling direction of the photoreceptor drum (20) at a position facing the photoreceptor drum (20). The thinned layer of the toner is transferred to the position facing the photoreceptor drum (20) and to the surface thereof to develop an electrostatic latent image according to the developing bias applied to the developing roller (103) and a latent image electric field formed by the electrostatic latent image. At a position where the toner remaining untransferred on the developing roller (103) returns into the toner feeding room (102), a seal (108) is located contacting the developing roller (103) to prevent the toner form leaking out of the image developer.

Having generally described this invention, further understanding can be obtained by reference to certain specific examples which are provided herein for the purpose of illustration only and are not intended to be limiting. In the descriptions in the following examples, the numbers represent weight ratios in parts, unless otherwise specified.

### EXAMPLES

### Preparation of the First Binder Resin

600 g of styrene, 110 g of butylacrylate, 30 g of an acrylic acid as vinyl monomers and 30 g of dicumylperoxide as a polymerization initiator were placed in a dripping funnel to prepare a mixed liquid. 1,230 g of polyoxypropylene (2,2)-2,2-bis(4-hydroxyphenyl)propane, 290 g of polyoxyethylene (2,2)-2,2-bis(4-hydroxyphenyl)propane, 250 g of isododecenylsuccinicanhydride, 310 g of terephthalic acid and 180 g of 1,2,4-benznetricarbonateanhydride as polyol; and 7 g of dibutyltinoxide as an esterification catalyst were mixed to prepare a polyester monomer. 4 parts by weight of paraffin wax having a melting point of 73.3° C. and a half-value width of the endothermic peak of 4° C. when measured with a differential scanning calorimeter and 100 parts by weight of the polyester monomer were placed in a 5-litter four-neck flask having a thermometer, a stainless stirrer, a falling condenser and a nitrogen inlet tube to prepare a mixture. The mixed liquid including the vinyl monomers and polymerization initiator was dropped for 1 hr in flask under a nitrogen atmosphere in a mantle heater at 160° C. while the mixture therein was stirred. After an addition polymerization was continued for 2 hrs at 160° C., a condensation polymerization was performed at 230° C. The polymerization degree was traced by a softening point measured with a constant-load extrusion capillary rheometer, and the reaction was finished when the resultant resin had a softening point of 152° C.

### [Preparation of the Second Binder Resin]

2,210 g of polyoxypropylene(2,2)-2,2-bis(4-hydroxyphenyl)propane, 850 g of terephthalic acid and 120 g of 1,2,4-benznetricarbonateanhydride as polyol; and 0.5 g of dibutyltinoxide as an esterification catalyst were placed in a 5-litter four-neck flask having a thermometer, a stainless stirrer, a falling condenser and a nitrogen inlet tube and subjected to a condensation polymerization under a nitrogen atmosphere in a mantle heater at 230° C. The polymerization degree was traced by a softening point measured with a constant-load extrusion capillary rheometer, and the reaction was finished when the resultant resin had a desired softening point of 107° C.

### Examples 1 to 9 and Comparative Examples 1 to 4

Toners of Examples 1 to 9 and Comparative Examples 1 to 4 were prepared by the following formulations and method so as to have softening points shown in Table 1-2, respectively:

### Example 1

| | |
|---|---|
| First binder resin | 30 |
| Second binder resin | 70 |
| C.I. Pigment Red 57-1 | 4 |
| Paraffin wax | 4 |
| having a melting point of 72.5° C. | |
| Charge controlling agent | 1.5 |
| LR-147 from Nippon Carlit Co., Ltd. | |

### Example 2

| | |
|---|---|
| First binder resin | 80 |
| Second binder resin | 20 |
| C.I. Pigment Red 57-1 | 4 |
| Paraffin wax | 9 |
| having a melting point of 72.5° C. | |
| Boron charge controlling agent | 1.5 |
| LR-147 from Nippon Carlit Co., Ltd. | |

### Example 3

| | |
|---|---|
| First binder resin | 60 |
| Second binder resin | 40 |
| C.I. Pigment Red 57-1 | 4 |
| Paraffin wax | 4 |
| having a melting point of 72.5° C. | |
| Boron charge controlling agent | 1.5 |
| LR-147 from Nippon Carlit Co., Ltd. | |

### Example 4

| | |
|---|---|
| First binder resin | 40 |
| Second binder resin | 60 |
| C.I. Pigment Red 57-1 | 4 |
| Paraffin wax | 2.5 |
| having a melting point of 72.5° C. | |
| Boron charge controlling agent | 1.5 |
| LR-147 from Nippon Carlit Co., Ltd. | |

### Example 5

| | |
|---|---|
| First binder resin | 60 |
| Second binder resin | 40 |
| C.I. Pigment Red 57-1 | 4 |
| Paraffin wax | 11 |
| having a melting point of 72.5° C. | |
| Boron charge controlling agent | 1.5 |
| LR-147 from Nippon Carlit Co., Ltd. | |

### Example 6

| | |
|---|---|
| First binder resin | 60 |
| Second binder resin | 40 |
| C.I. Pigment Red 57-1 | 4 |
| Paraffin wax | 6 |
| having a melting point of 72.5° C. | |
| Boron charge controlling agent | 1.5 |
| LR-147 from Nippon Carlit Co., Ltd. | |

### Example 7

| | |
|---|---|
| First binder resin | 60 |
| Second binder resin | 40 |
| C.I. Pigment Red 57-1 | 4 |
| Paraffin wax | 6 |
| having a melting point of 72.5° C. | |
| Boron charge controlling agent | 1.5 |
| LR-147 from Nippon Carlit Co., Ltd. | |

### Example 8

| | |
|---|---|
| First binder resin | 95 |
| Second binder resin | 5 |
| C.I. Pigment Red 57-1 | 4 |
| Paraffin wax | 5 |
| having a melting point of 72.5° C. | |
| Boron charge controlling agent | 1.5 |
| LR-147 from Nippon Carlit Co., Ltd. | |

### Example 9

| | |
|---|---|
| First binder resin | 5 |
| Second binder resin | 95 |
| C.I. Pigment Red 57-1 | 4 |
| Paraffin wax | 5 |
| having a melting point of 72.5° C. | |
| Boron charge controlling agent | 1.5 |
| LR-147 from Nippon Carlit Co., Ltd. | |

### Comparative Example 1

| | |
|---|---|
| First binder resin | 60 |
| Second binder resin | 40 |
| C.I. Pigment Red 57-1 | 4 |
| Paraffin wax | 4 |
| having a melting point of 72.5° C. | |
| Boron charge controlling agent | 1.5 |
| LR-147 from Nippon Carlit Co., Ltd. | |

### Comparative Example 2

| | |
|---|---|
| First binder resin | 40 |
| Second binder resin | 60 |
| C.I. Pigment Red 57-1 | 4 |
| Paraffin wax | 3.5 |
| having a melting point of 72.5° C. | |
| Boron charge controlling agent | 1.5 |
| LR-147 from Nippon Carlit Co., Ltd. | |

### Comparative Example 3

| | |
|---|---|
| First binder resin | 60 |
| Second binder resin | 40 |
| C.I. Pigment Red 57-1 | 4 |
| Paraffin wax | 4 |
| having a melting point of 72.5° C. | |
| Boron charge controlling agent | 1.5 |
| LR-147 from Nippon Carlit Co., Ltd. | |

### Comparative Example 4

| | |
|---|---|
| First binder resin | 40 |
| Second binder resin | 60 |
| C.I. Pigment Red 57-1 | 4 |
| Paraffin wax | 4 |
| having a melting point of 72.5° C. | |
| Boron charge controlling agent | 1.5 |
| LR-147 from Nippon Carlit Co., Ltd. | |

After the above-mentioned materials of each Example and Comparative Example were fully mixed in a HENSCHEL MIXER to prepare amixture, the mixture was melted and kneaded in abiaxial extruder PCM-30 from Ikegai Corp. to prepare a kneaded mixture. After the kneaded mixture was extended upon application of pressure with a cooling press roller to have a thickness of 2 mm and cooled with a cooling belt to prepare a hardened mixture, the hardened mixture was crushed with a feather mill to prepare a crushed mixture. Then, the crushed mixture was pulverized with a mechanical pulverizer KTM from Kawasaki Heavy Industries, Ltd. to have a volume-average particle diameter of from 10 to 12 μm and further pulverized with a jet pulverizer IDS from Nippon Pneumatic Mfg. Co., Ltd. to prepare a pulverized mixture. The pulverized mixture was classified with a rotor classifier 100 ATP from Hosokawa Micron Group to prepare a colored particulate resin having a desired particle diameter and a desired circularity. A desired amount of an inorganic particulate material CAB-O-SIL TS530 from Cabot Corp. was mixed with 100 parts by weight of the colored particulate resin in HENSCHEL MIXER to prepare magenta toner particles. The stronger the mixing, the smaller the diameter of the wax and the less the wax exposure on the surface of the toner. In addition, the lower the kneading temperature, the stronger the shearing strength against the resin, the smaller the diameter of the wax and the less the wax exposure on the surface of the toner.

The softening point Tm was measured as follows:

1.5 g of a sample is placed in flow tester CFT-500 from Shimadzu Corp. using a die having a diameter of 1.0 mm and a height of 1.0 mm, and a temperature at a half of the sample flowed at a programming speed of 3.0° C./min, preheating time of 180 sec, a load of 30 kgs from 80 to 140° C. was determined as Tm.

The maximum endothermic peak was measured a differential scanning calorimeter DSC6200 from Seiko Instruments Inc. The sample heated up to 200° C. was cooled at a programming speed of 10° C./min.

The particle diameter distribution of the toner can be measured by a Coulter counter TA-II or Coulter Multisizer II from Beckman Coulter, Inc. as follows:

0.1 to 5 ml of a detergent, preferably alkylbenzene sulfonate is included as a dispersant in 100 to 150 ml of the electrolyte ISOTON-II from Coulter Scientific Japan, Ltd., which is a NaCl aqueous solution including an elemental sodium content of 1%;

2 to 20 mg of a toner sample is included in the electrolyte to be suspended therein, and the suspended toner is dispersed by an ultrasonic disperser for about 1 to 3 min to prepare a sample dispersion liquid; and

a volume and a number of the toner particles for each of the following channels are measured by the above-mentioned measurer using an aperture of 100 μm to determine a weight distribution and a number distribution:

2.00 to 2.52 μm; 2.52 to 3.17 μm; 3.17 to 4.00 μm; 4.00 to 5.04 μm; 5.04 to 6.35 μm; 6.35 to 8.00 μm; 8.00 to 10.08 μm; 10.08 to 12.70 μm; 12.70 to 16.00 μm; 16.00 to 20.20 μm; 20.20 to 25.40 μm; 25.40 to 32.00 μm; and 32.00 to 40.30 μm,

and a weight-average particle diameter and a number-average particle diameter of the toner can be determined therefrom.

The wax exposure on the surface of the toner was measured as follows.

After 7 ml of n-hexane was mixed with 1.0 g of the toner before an external additive by a roll mill at 120 rpm for 1 min to prepare a solution, the solution was subjected to a suction filtration and n-hexane was removed by vacuum drying to prepare residues. The wax exposure on the surface of the toner A (mg/g) was determined by the following formula:

A=Weight of the residues (mg)/the content (g) of the wax in 1.0 g of the toner

The adherence strength of silica was measured as follows.

After 2 g of the toner was fully blended with 30 ml of a surfactant solution diluted tenfold to prepare a mixture, an energy was applied thereto at 40 W for 1 min by an ultrasonic homogenizer to separate the silica from the toner. Then, after the silica was washed and dried, a ratio of an adherence amount of the silica before separated from the toner (pellet of 2 g) to an adherence amount thereof after separated from the toner (pellet of 2 g) was measured, using a wavelength-dispersive X-ray fluorescence analyzer XRF1700 from Shimadzu Corp. An energy of 1N/cm² was applied to 2 g of the toner for 60 sec to form a pellet thereof.

The toner in a range of 2 mm×100 mm on the developing roller was suctioned and the weight of the trapped toner was measured to determined an adherence amount (mg/cm²) thereof per a unit area.

Anchoring was evaluated as follows.

After 5,000 images having an image area of 5% were produced by color laser printer ipsio CS2500 from Ricoh Company, ltd., a solid mage was produced to visually evaluate stripe images thereon.

◯: No problem

Δ: Blank stripes are observed, but acceptable

X: Blank stripes are observed, and unacceptable

A two-component developer including 5 parts of the toner and 95 parts of carrier coated with silicone resin was set in modified ipsio CX7500 the fixer was taken out from. Six solid unfixed toner images having a 3-millimeter-long blank at the end in the longitudinal direction were produced on transfer papers TYPE 6200Y from Ricoh Company, Ltd. such that the toner thereon had a thickness of 1.1±0.1 mg/cm².

The fixer was taken out from ipsio CX2500 and modified to a fixing tester having a desired temperature and a linear speed of the fixing belt.

The six images were fixed from the 3-millimeter-long blank by the fixing tester at a linear speed of 125 mm/sec and temperatures of 140, 150, 160, 170, 180 and 19° C., respectively.

◯: Not less than 5 images were normally fixed

Δ: Not less than 2 less than 5 images were normally fixed

X: Less than 2 images were normally fixed

TABLE 1-1

| | | | Developing | Developing | |
|---|---|---|---|---|---|
| | Wax | | roller | Roller | |
| | exposure | | diameter | Linear speed | |
| | mg/g | Scope | mm | mm/sec | Scope |
| Example 1 | 1.8 | Suitable | 10.0 | 150.0 | Suitable |
| Example 2 | 8.1 | Suitable | 10.0 | 120.0 | Suitable |
| Example 3 | 1.8 | Suitable | 5.0 | 150.0 | Suitable |
| Example 4 | 4.2 | Suitable | 7.5 | 150.0 | Suitable |
| Example 5 | 4.5 | Suitable | 7.5 | 150.0 | Suitable |
| Example 6 | 3.3 | Suitable | 7.5 | 200.0 | Suitable |
| Example 7 | 2.6 | Suitable | 7.5 | 200.0 | Suitable |
| Example 8 | 4.5 | Suitable | 7.5 | 200.0 | Suitable |
| Example 9 | 2.0 | Suitable | 7.5 | 200.0 | Suitable |
| Comparative | 12.0 | X | 10.0 | 150.0 | Suitable |
| Example 1 | | | | | |
| Comparative | 0.9 | X | 5.0 | 150.0 | Suitable |
| Example 2 | | | | | |
| Comparative | 3.0 | Suitable | 7.5 | 90.0 | X |
| Example 3 | | | | | |
| Comparative | 3.0 | Suitable | 7.5 | 310.0 | X |
| Example 4 | | | | | |

TABLE 1-2

| | Maximum | | | | | |
|---|---|---|---|---|---|---|
| | Endothermic | | Softening | | Wax % by | |
| | Peak | | Point | | weight | |
| | ° C. | Scope | ° C. | Scope | % | Scope |
| Example 1 | 66 | Suitable | 117 | Suitable | 4.0 | Suitable |
| Example 2 | 78 | Suitable | 140 | Suitable | 9.0 | Suitable |
| Example 3 | 69 | Suitable | 132 | Suitable | 4.0 | Suitable |
| Example 4 | 74 | Suitable | 120 | Suitable | 2.5 | Suitable |
| Example 5 | 70 | Suitable | 134 | Suitable | 11.0 | X |
| Example 6 | 62 | X | 130 | Suitable | 6.0 | X |
| Example 7 | 86 | X | 132 | Suitable | 6.0 | Suitable |
| Example 8 | 77 | Suitable | 147 | X | 5.0 | Suitable |
| Example 9 | 67 | Suitable | 108 | X | 5.0 | Suitable |
| Comparative | 67 | Suitable | 135 | Suitable | 4.0 | Suitable |
| Example 1 | | | | | | |
| Comparative | 76 | Suitable | 125 | Suitable | 3.5 | Suitable |
| Example 2 | | | | | | |
| Comparative | 72 | Suitable | 123 | Suitable | 4.0 | Suitable |
| Example 3 | | | | | | |
| Comparative | 72 | Suitable | 123 | Suitable | 4.0 | Suitable |
| Example 4 | | | | | | |

TABLE 1-3

| | Overall | | |
|---|---|---|---|
| | evaluation | Anchoring | Separativeness |
| Example 1 | ◯ | ◯ | ◯ |
| Example 2 | ◯ | ◯ | ◯ |
| Example 3 | ◯ | ◯ | ◯ |
| Example 4 | Δ | ◯ | Δ |
| Example 5 | Δ | Δ | ◯ |
| Example 6 | Δ | Δ | ◯ |
| Example 7 | Δ | ◯ | Δ |
| Example 8 | Δ | ◯ | Δ |
| Example 9 | Δ | Δ | ◯ |
| Comparative | X | X | ◯ |
| Example 1 | | | |
| Comparative | X | ◯ | X |
| Example 2 | | | |
| Comparative | X | ◯ | X |
| Example 3 | | | |
| Comparative | X | X | ◯ |
| Example 4 | | | |

This application claims priority and contains subject matter related to Japanese Patent Application No. 2007-330202, filed on Dec. 21, 2007, the entire contents of which are hereby incorporated by reference.

Having now fully described the invention, it will be apparent to one of ordinary skill in the art that many changes and modifications can be made thereto without departing from the spirit and scope of the invention as set forth therein.

What is claimed as new and desired to be secured by Letters Patent Of the United States is:

1. An image forming method, comprising:
forming an electrostatic latent image on a latent image bearer;
forming a thin layer of a toner on a developing roller with a thin-layer forming member; and
feeding the toner with the developing roller to the electrostatic latent image to develop the electrostatic latent image,
wherein the toner is a pulverized toner, comprising:
a binder resin;
a wax; and
an inorganic particulate material, and
wherein the following relationships (1) to (3) are satisfied:
300≧v≧100 (1)
10≧R≧5 (2)
R²/12≧A≧150/v (3)
wherein v represents a peripheral speed of the developing roller; R represents a diameter of the developing roller; and Are presents an exposure of the wax on the surface of the toner.

2. The image forming method of claim 1, wherein the toner comprises the wax in an amount of from 3 to 10% by weight.

3. The image forming method of claim 1, wherein the toner has a maximum endothermic peak in a range of from 65 to 85° C. in a range of 30 to 200° C. of an endothermic curve obtained by differential scanning calorimetry.

4. The image forming method of claim 1, wherein the toner has a softening point of from 110 to 140° C.

5. The image forming method of claim 1, wherein the toner has a volume-average particle diameter of from 5.0 to 10.0 μm.

6. The image forming method of claim 1, wherein the toner comprises the inorganic particulate material in an amount of from 2.0 to 4.5 parts by weight.

7. The image forming method of claim 1, wherein the inorganic particulate material has an adherence strength of from 30 to 80%.

8. The image forming method of claim 1, wherein the toner adheres on the developing roller in an amount of 7 mg/cm² or less.

9. A toner for use in a process cartridge comprising:
a latent image bearer configured to bear an electrostatic latent image;
a developing roller configured to feed a toner to the electrostatic latent image to develop the electrostatic latent image;
wherein the following relationships (1) to (2) are satisfied:
300≧v≧100 (1)
10≧R≧5 (2)
wherein v represents a peripheral speed of the developing roller; and R represents a diameter of the developing roller, and
wherein the toner satisfies the following relationship (3):
R²/12≧A≧150/v (3)
wherein A represents an exposure of the wax on the surface of the toner.

10. An image forming apparatus, comprising:
a latent image bearer configured to bear an electrostatic latent image;
a developing roller configured to feed a toner to the electrostatic latent image to develop the electrostatic latent image;
a thin-layer forming member configured to form a thin layer of a toner; and
a toner container,
wherein the following relationships (1) to (2) are satisfied:
300≧v≧100 (1)
10≧R≧5 (2)
wherein v represents a peripheral speed of the developing roller; and R represents a diameter of the developing roller, and
wherein the toner satisfies the following relationship (3):
R²/12≧A≧150/v (3)
wherein A represents an exposure of the wax on the surface of the toner.
